(19) United States
(12) Patent Application Publication
(10) Pub. No.: US 2011/0113068 A1
(43) Pub. Date: May 12, 2011

(54) SYSTEM AND METHOD FOR MANAGING MULTIPLE USER REGISTRATIONS

(75) Inventors: Jie Ouyang, San Diego, CA (US); Xinfang Zhao, San Diego, CA (US)

(73) Assignees: Xinfang Zhao, San Diego, CA (US); TIPSWOW LLC, San Diego, CA (US)

(21) Appl. No.: 12/617,615

(22) Filed: Nov. 12, 2009

(51) Int. Cl. G06F 17/00; G06F 15/16

(52) U.S. Cl. 707/784; 709/217; 707/E17.005; 707/E17.032

(57) ABSTRACT

The present invention represents system and method for managing multiple user registrations. An exemplary system comprises a user registration management tool and a service provider registration information system. The user registration management tool allows an Internet user to manage his or her user registrations. The service provider registration information system hosted to at least one server provides interfaces for managing registration information of a plurality of service providers, for managing user registration requests and for sharing registration information with other service provider registration information systems via a Network. An exemplary method for processing a user registration in an integration process comprises receiving a request of user registration to a service provider from an Internet user, sending a registration request document at the user registration management tool, transmitting the registration request document at the service provider registration information system, and receiving the registration request document and processing a user registration at the service provider.

### FIELD OF THE INVENTION

The present invention generally relates to the field of online registration and, more specifically, a system and method for managing multiple user registrations.

### BACKGROUND OF THE INVENTION

Do you remember how many web sites for which you have registered to be a member? Typically, an Internet user often registers a number of subscriptions or services in order to make purchases, to obtain content information and to get services. However it is impractical for an Internet user to remember all of web sites for which he or she has registered to be a member before. It is very often that an Internet user forgets his or her user registration to some web site and will make another user registration when he visits that web site again. In order to track user registrations and avoid duplicate user registrations, an Internet user should keep records of his or her user registrations in some way. A common way to keep user registrations is to write down them as records and store these records in a file, for example, an excel spreadsheet. But it is inconvenient to track and update user registration records from a file. It is expected that an Internet user can easily track and update his or her user registrations in demand via the Internet.

As described above, an Internet user often has to register to a number of web sites for subscriptions or services. In a typical web-based registration process, an Internet user needs to fill a form with login ID, user password with or without other personal information such as name, address, email address, phone number. An Internet user has to go through the similar registration process to provide user profile information over and over when registering for a new membership at every individual web site.

There were many efforts in trying to simplify user registrations. One of them is to use a single sign-on process based on Open ID technology. The single sign-on process allows an Internet user to access multiple web sites with only one user registration. The single sign-on process is good to obtain content from information service sites or to post articles to blog sites. However, the single sign-on process is not a substitute for systems that authenticate and authorize a user to perform a web-based transaction. At many web sites, especially in providing commercial services such as purchases or financial services, the single sign-on process cannot satisfy the business requirements. Usually these commercial web sites require their own user registrations in consideration of security, customer personalization, customer loyalty, billing requirement and marketing promotion.

In a prior web-based registration method, the registration method loads user information through a central data repository that stores user profile information. Therefore an Internet user does not have to fill the same information repeatedly when signing up a new membership. However, an Internet user still needs to visit each individual web site and to go through the various processes for user registrations. Further an Internet user has to go through every web site in order to update his or her existed user registrations one at once when his or her user information (e.g. contact address) is changed.

There exists a need for a system that is capable of managing multiple user registrations efficiently. The system is expected to provide a simple procedure to process user registrations and to allow an Internet user to easily create, update and track his or her user registrations via the Internet.

### SUMMARY OF THE INVENTION

In accordance with the present invention, system and method for managing multiple user registrations allow an Internet user to efficiently manage his or her user registrations via the Internet.

A system for managing multiple user registrations, comprising
a) a user registration management tool, said user registration management tool comprising
   1) a user registration management interface, said user registration management interface comprising
      i) means for creating user registration records, said means creating user registration records allowing an Internet user to create a user registration record to a service provider within a plurality of service providers;
      ii) means for updating user registration records, said means updating user registration records allowing the Internet user to update said user registration record;
      iii) means for managing user registration profiles, said means for managing user registration profiles allowing the Internet user to create said user registration profiles;
      iv) means for managing user registration books, said means for managing user registration books allowing the Internet user to create said user registration books;
   2) a user registration database, said user registration database comprising
      i) user registration profiles, said user registration profiles storing user information for user registrations;
      ii) user registration records, said user registration records storing records of user registrations to said plurality of service providers;
      iii) user registration books, said user registration books storing a collection of said user registration records;
b) a service provider registration information system, said service provider registration information system hosted on at least one server comprising
   1) a service provide registration management interface, said service provide registration management interface comprising
      i) means for managing service provider registration information, said means for managing service provider registration information comprising
         A) registering service providers, said registering service provider allowing said plurality of service providers to register to said service provider registration information system;
         B) creating service provider registration information;
         C) updating said service provider registration information;
         D) retrieving said service provider registration information;
      ii) means for managing user registration requests, said means for managing user registration requests comprising
         A) transmitting a registration request document;
         B) mapping said registration request document between said user registration management tool and said plurality of service providers;
         C) transmitting a registration confirmation document;
         D) mapping said registration confirmation document between said user registration management tool and said plurality of service providers;
      iii) means for sharing with other registration information systems, said means for sharing with other registration information systems comprising
         A) connecting to a plurality of other service provider registration information systems via the Network;
         B) obtaining authority access to the registration information of said plurality of service providers;
         C) sharing the registration information of said plurality of service providers with said plurality of other service provider registration information systems;
   2) a registration information database, said registration information database comprising
      i) service provider registration information, said service provider registration information storing the registration information of said plurality of service providers;
      ii) user registration request records, said user registration request records storing the user registration requests;
      iii) shared registration information systems, said shared registration information systems storing information of said plurality of other service provider registration information systems.

A method for processing a user registration, comprising:
a) receiving a request from an Internet user to create a user registration request to a service provider within a plurality of service providers at a user registration management tool;
b) encrypting a user password for said user registration request at said user registration management tool;
c) Creating a registration request document for said user registration request at said user registration management tool;
d) sending said registration request document from said user registration management tool to a service provider registration information system;
e) mapping said registration request document between said user registration management tool and the service provider at said service provider registration information system;
f) transmitting said registration request document from said service provider registration information system to the service provider;
g) receiving said registration request document from said service provider registration information system at the service provider;
h) processing a user registration based on said registration request document at the service provider.

### BRIEF DESCRIPTION OF THE DRAWINGS

FIG. 1 illustrates a possible embodiment of a system for managing multiple user registrations.

FIG. 2 illustrates a possible embodiment of a system for managing multiple user registrations.

FIG. 3 illustrates a possible embodiment of a system for managing multiple user registrations.

FIG. 4 illustrates a possible embodiment of a registration request document.

FIG. 5 illustrates a possible embodiment of a registration confirmation document.

FIG. 6 illustrates a possible embodiment of a method for processing a user registration in an integration process.

FIG. 7 illustrates a possible embodiment of a method for processing a user registration in flowchart diagram of creating a new user registration.

FIG. 8 illustrates a possible embodiment of a method for processing a user registration in flowchart diagram of updating an existed user registration.

FIG. 9 illustrates a possible embodiment of a method for processing a user registration in an integration process of encrypting and decrypting a user password.

### DETAILED DESCRIPTION

The present invention will now be discussed in detail with regard to the attached figures which were briefly described above. In the following description, numerous specific details are set forth illustrating the best model for practicing the invention and enabling one of ordinary skill in the art to make and use the invention. It will be obvious; however, the present invention may be practiced without many of these specific details. The present invention may be implemented in any suitable type of environment, including an Internet or network environment.

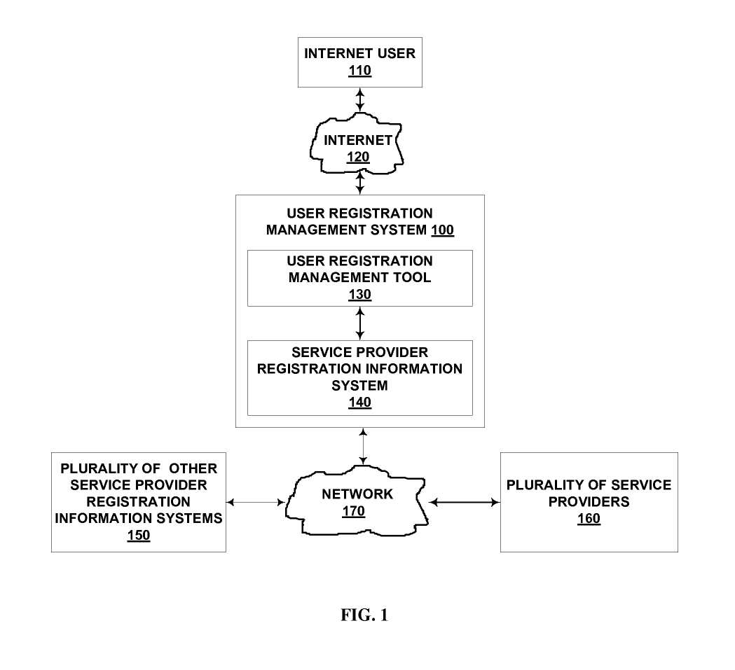

FIG. 1 illustrates a possible embodiment of a system for managing multiple user registrations in the form of a user registration management system 100. The user registration management system 100 comprises a user registration management tool 130 and a service provider registration information system 140. The user registration management system 100 may connect to a plurality of other service provider registration information systems 150 and a plurality of service providers 160 via a network 170. The plurality of other service provider registration information systems 150 may connect to the plurality of service providers 160 via the network 170. An Internet user 110 may connect to the user registration management system 100 via an Internet 120.

The exemplary embodiment herein has no limitation on configuration and connectivity of the network 170. The network 170 could comprise the Internet, an intranet, an extranet, a local network, a wide area network, a wired network, a wireless network, or any combination of thereof. The user registration management system 100 may communicate to the network 170 via any method of network connection existed or developed in the future including, but not limited to wired, wireless, modem, cable modem, Ethernet, Digital Subscriber Line (DSL), Virtual Private Network (VPN) and/or any combination thereof.

The service provider registration information system 140 is responsible for managing service providers. A service provider within the plurality of service providers 160 may register to join either the service provider registration information system 140 or anyone within the plurality of other service provider registration information systems 150. The service provider registration information system 140 may communicate with anyone within the plurality of other service provider registration information systems 150 via the network 170 in order to share or exchange registration information of the plurality of service providers 160. By sharing or exchanging of the registration information of the plurality of service providers 160 with the plurality of other service provider registration information systems 150, the service provider registration information system 140 expands its capability in providing user registrations from as many service providers as possible. If a service provider within the plurality of service providers 160 is a registered member of the service provider registration information system 140, the service provider can be directly accessed by the service provider registration information system 140. If a service provider within the plurality of service providers 160 is not a registered member of the service provider registration information system 140, but is a registered member of someone within the plurality of other service provider registration information systems 150, the service provider can be indirectly accessed by the service provider registration information system 140 through sharing of the plurality of other service provider registration information systems 150.

The Internet user 110 may use a device including, but not limited to computer, laptop, and personal digital assistant (PDA) or mobile phone, to connect to the user registration management system 100 via the Internet 120. In a typical example, the user registration management tool 130 may be implemented as a web-based tool. The Internet user 110 signs up for a membership of the user registration management tool 130. After becoming a member of the user registration management tool 130, the Internet user 110 may be authorized to access the user registration management system 100 to manage his or her user registrations.

The user registration management tool 130 may connect to the service provider registration information system 140 in order to exchange information including, but not limited to the registration information of the service providers and user registration requests. The user registration management tool 130 and the service provider registration information system 140 may exist on either the same or different computers. The user registration management tool 130 and the service provider registration information system 140 may exist on the same or different servers as well as web sites.

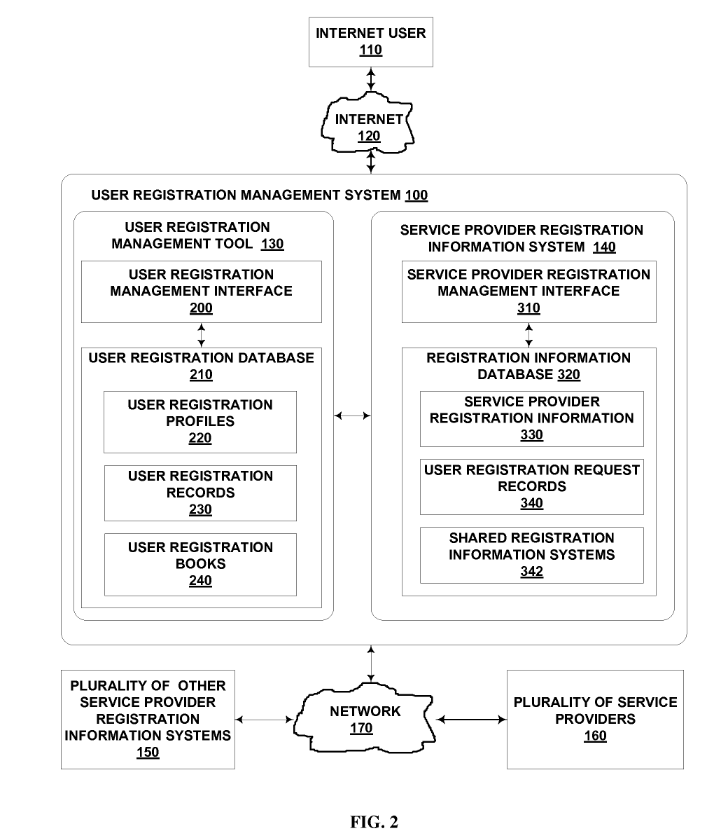

FIG. 2 illustrates an alternate embodiment of a system for managing multiple user registrations in form of the user registration management system 100. The user registration management system 100 comprises the user registration management tool 130 and the service provider registration information system 140.

The user registration management tool 130 comprises a user registration management interface 200 and a user registration database 210. The user registration database 210 comprises user registration profiles 220, user registration records 230 and user registration books 240.

The user registration profiles 220 may comprise profile id, user id, login id, encrypted password, login email, password hint, user contact name, user contact address and additional information. The profile id is used to identify a user registration profile. The user id is used to identify an Internet user. The login id is the login id of one or more user registrations. The encrypted password is the encrypted password of one or more user registrations. The login email may be the email address that is related to one or multiple user registrations. The password hint may be a string that would help a user to remember his or her password. The user contact name may include first name and last name. The user contact address may comprise street, city, state, country, postal code, phone and contact email. The additional information may include, but not limited to user authority, social security number and billing information.

The user registration records 230 may comprise user id, login id, encrypted password, password hint, login email, user registration profile id, registration information system id, service provider id, service provider name, service provider URL, automated delaying registration (ADR) flag, registration status and status. The user id is used to identify an Internet user. The login id is the login id of the user registration. It is recommended using current email address as login id. The encrypted password is the encrypted password of the user registration. The login email may be the email address associated with the user registration. The password hint may be a string that may help a user to remember the password. The user registration profile id may refer to one of the user registration profiles 220. The registration information system id is used to identify the service provider registration information system 140. The service provider id is used to identify the service provider within the plurality of service providers 160. The ADR flag indicates whether the user registration is created by an ADR process. The registration status may have values such as SUBMITTED, APPROVED, REJECTED, PENDING or CANCELLED. The status indicates the processing status of the user registration record, which may have values such as SUBMITTED, ACKNOWLEDGED, CONFIRMED, COMPLETED, FAILED, PENDING or CANCELLED.

The user registration books 240 may comprise book id and user registration record id. The user registration record id refers to one of the user registration records 230. Each of the user registration books 240 is a collection of one or more user registration records.

The service provider registration information system 140 comprises a service provider registration management interface 310 and a registration information database 320. The registration information database 320 comprises service provider registration information 330, user registration request records 340 and shared registration information systems 342.

The service provider registration information 330 may comprise service provider id, service provider name, service provider URL, registration request URL, service description, terms of use and registration policies, registration data requirement, registration method, password encryption method, contact address, contact email and contact phone. The service provider id may be used to identify the service provider. The service provider name may be the business name of the service provider. The service provider URL may be the URL of the service provide web site. The registration request URL may be the URL of the registration request to the service provider. The service description may provide a description of the service provide and its service. The registration terms and policies may represent the registration terms of use and policies which are required for the user registration of the service provider. The registration data requirement may indicate what user information should be included in one user registration to the service provider. For example, social security number may be an optional element in the registration data requirement, which may be required in some user registrations. The registration method may indicate what registration method is used by the user registration. The password encryption method may indicate what password encryption method is used by the user registration.

The user registration request records 340 may comprise record id, tool id, user id, source information system id, service provider id, registration request URL, registration method, data encryption method, registration request document, registration confirmation document, status and document type. The record id may be used to identify a user registration request record. The tool id may be used to identify the user registration management tool 130. The user id may be used to identify a user. The source information system id may be used to identify the service provider registration information system 140. The service provider id may be used to identify one service provide within the plurality of service providers 160. The registration request URL is the URL of the user registration request to the service provider. The registration method may indicate what registration method is used by the user registration request. The data encryption method may indicate what data encryption method is used by the user registration request. The registration request document may contain a document of the user registration request. The registration confirmation document may contain a document of a user registration confirmation. The status may indicate the processing status of the user registration request record. The status may have values such as REQUEST_RECEIVED, REQUEST_DELIVERED, CONFIRMTION_RECEIVED, CONFIRMATION_DELIVERED, COMPLETED, FAILED, PENDING or CANCELLED. The document type may indicate what document type is used in the user registration request. The document type may be, but not limited to plain text, Extensible Markup Language (XML), Electronic Data Interchange (EDI), Microsoft Excel (XLS) or Portable Document Format (PDF).

The shared registration information systems 342 may comprise information system id, information system name, information system description, contact address, contact phone, connection protocol, connection URL, data encryption method and document type. The information system id may be used to identify one within the plurality of other service provider registration information systems 150. The information system description may provide a description of the service provider registration information system. The connection protocol may indicate what connection protocol is used by the service provider registration information system. The connection protocol may include, but not limited to HTTP/HTTPS, FTP/SFTP, SMTP, AS2, AS3, SOAP or EDI Van. The connection URL may be the URL of the service provider registration information system. The data encryption method may indicate what data encryption method is used to encrypt data by the service provider registration information system. The document type may indicate what document type is used by the service provider registration information system. The document type may be, but not limited to plain text, XML, EDI, XLS or PDF.

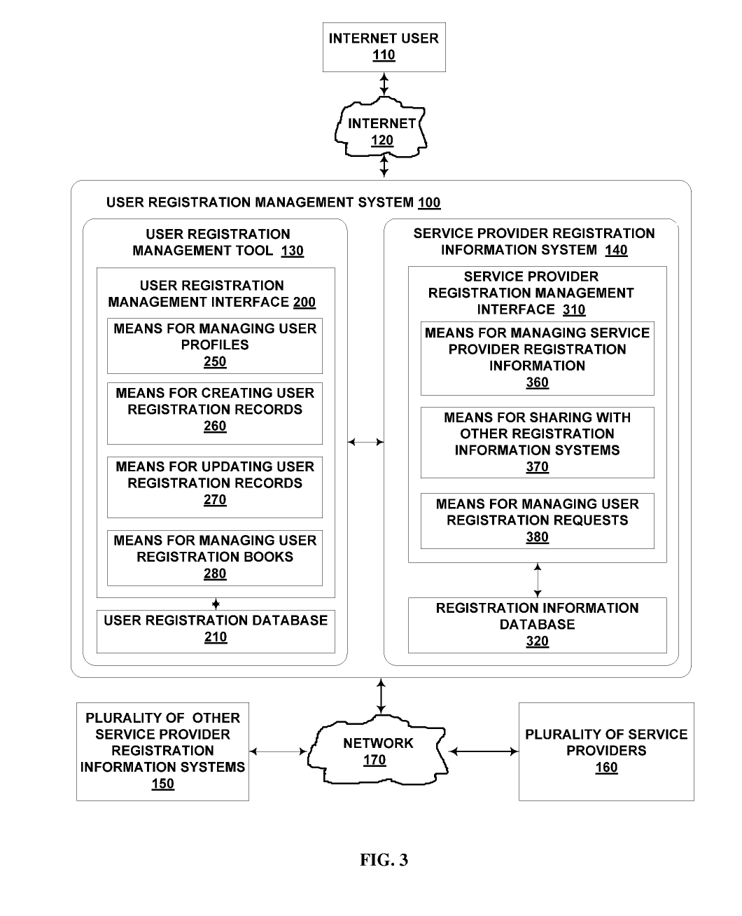

FIG. 3 illustrates an alternate embodiment of a system for managing multiple user registrations in form of the user registration management system 100. The user registration management interface 200 comprises means for managing user registration profiles 250, means for creating user registration records 260, means for updating user registration records 270 and means for managing user registration books 280. The service provider registration management interface 310 comprises means for managing service provider registration information 360, means for sharing with other registration information systems 370 and means for managing user registration requests 380.

The Internet user 110 may access the user registration management tool 130 and use the user registration management interface 200 to perform activities of managing the user registration profiles 220, create or update the user registration records 230 and managing the user registration books 240.

The means for managing user registration profiles 250 may allow the Internet user 110 to manage his or her user registration profiles. With the means for managing user registration profiles 250, the Internet user 110 may create, update, delete or view his or her user registration profiles 220. The Internet user 110 may create one or more user registration profiles.

The means for creating user registration records 260 may allow the Internet user 110 to create a new record of the user registration records 230. A user registration record includes a user id, a login id, a service provider URL. For each within the plurality of service providers 160, the Internet user 110 may be allowed to create one user registration record. With the means for creating user registration records 260, the Internet user 110 may create a new user registration to one within the plurality of service providers 160 through the ADR process or the conventional registration process. The ADR process will be discussed later. For an existed user registration that the Internet user 110 registered before, the Internet user 110 may create a user registration record for the existed user registration by manually entering the user registration information.

The means for updating user registration records 270 may allow the Internet user 110 to update his or her user registration records 230. With the means for updating user registration records 270, the Internet user 110 may update one or more user registration records 230 by changing user registration information such as password, contact address or other registration information. Specially, if a user registration record is created through the ADR process, the user registration may be updated automatically through the ADR process with the means for updating user registration records 270. Therefore, in order to change user registration information such as password or contact address, the Internet user 110 may update these data locally within the user registration management tool 130 instead of going to the web site of the service provider.

The means for managing user registration books 280 may allow the Internet user 110 to manage his or her user registration books 240. A user registration book comprises a collection of the user registration records. With the means for managing user registration books 280, the Internet user 110 may create, update, delete or view his or her user registration books 240. With the means for managing user registration books 280, the Internet user 110 may import or export his or her user registration books 240. The resource of importing or exporting may be a file or a URL. The data format of importing or exporting may be, but not limited to plain text, XML, EDI, XSL or PDF.

The means for managing service provider registration information 360 may be used to manage the service provider registration information 330. The means for managing service provider registration information 360 comprises a) registering service providers, said registering service provider allowing said plurality of service providers to register to said service provider registration information system; b) creating service provider registration information; c) updating said service provider registration information; d) retrieving said service provider registration information.

With the means for managing service provider registration information 360, a service provider may sign up to the service provider registration information system 140 and be placed into the plurality of service providers 160. With the means for managing service provider registration information 360, the service provider registration information 330 may be created, updated, deleted, retrieved or viewed. With the means for managing service provider registration information 360, the service provider registration information 330 may be imported or exported. The resource of importing or exporting may be a file or a URL. The data format of importing or exporting may be, not limited to plain text, XML, EDI, XSL or PDF.

The means for sharing with other registration information systems 370 may use the shared registration information systems 342 to share the service provider registration information 330 within the plurality of other service provider registration information systems 150. The means for sharing with other registration information systems 370 may comprise a) connecting to a plurality of other service provider registration information systems via the Network; b) obtaining authority access to the registration information of said plurality of service providers; c) sharing the registration information of said plurality of service providers with said plurality of other service provider registration information systems.

With the means for sharing with other registration information systems 370, the service provider registration information system 140 is able to communication with anyone within the plurality of other service provider registration information systems 150 via the Network 170 to exchange or share the service provider registration information of the plurality of service providers 160. With the means for sharing with other registration information systems 370, the plurality of other service provider registration information systems 150 may communicate with one another via the Network 170 to exchange or share the service provider registration information of the plurality of service providers 160.

The means for managing user registration requests 380 may be used to manage user registration request records 340. The means for managing user registration requests 380 may comprise a) transmitting a registration request document; b) mapping said registration request document between said user registration management tool and said plurality of service providers; c) transmitting a registration confirmation document; d) mapping said registration confirmation document between said user registration management tool and said plurality of service providers.

With the means for managing user registration requests 380, the user registration request records 340 may be created, updated, tracked or viewed. With the means for managing user registration requests 380, the service provider registration information system 140 may transmit user registration requests or registration request documents between the user registration management tool 130 and the plurality of service providers 160.

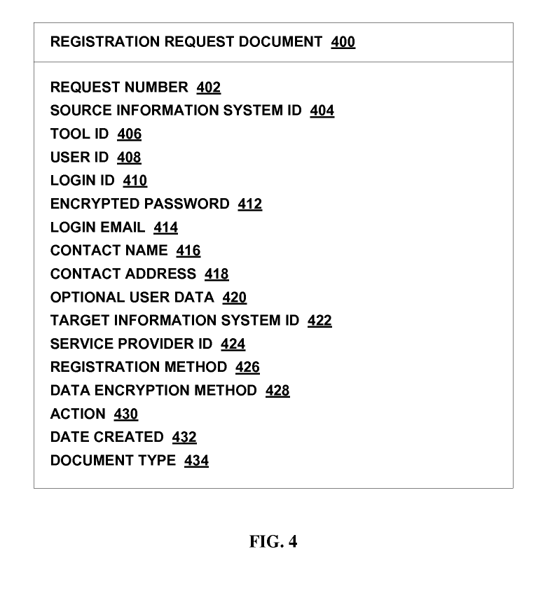

FIG. 4 illustrates an embodiment of a registration request document 400. The registration request document 400 may comprise request number 402, source information system id 404, tool id 406, user id 408, login id 410, encrypted password 412, login email 414, contact name 416, contact address 418, optional user data 420, target information system id 422, service provider id 424, registration method 426, data encryption method 428, action 430, date created 432 and document type 434. The request number 402 may be used identify a user registration request alone or combined with other fields. The source information system id 404 may be used to identify the service provider registration information system 140, which receives the user registration request from the user registration management tool 130. The tool id 406 may be used to identify the user registration management tool 130. The user id 408 may be used to identify a user within the user registration management tool 130. The login id 410, encrypted password 412 and login email 414 may be login id, encrypted password and login email of the user registration respectively. The contact name 416 may include first name and last name of a user. The contact address 418 may include street, city, state, country, postal code and phone number. The optional user data 420 may include optional user data such user authority, social security number and billing information. The target information system id 422 may be used to identify the service provider registration information system 140, which is the direct owner of the service provider for the user registration request. The service provider id 424 may be used to identify the service provider that will receive the user registration request. The registration method 426 may indicate which registration method is used in the user registration request. The data encryption method 428 may indicate which data encryption method is used in the user registration request. The action 430 may indicate whether the user registration request is to create a new user registration or to update an existed user registration. The date created 432 may be the date and time when the user registration request is created. The document type 434 may indicate which document type is used in the registration request document. The registration request document 400 may use any document types that include, but not limited to plain text, XML, EDI, XLS or PDF.

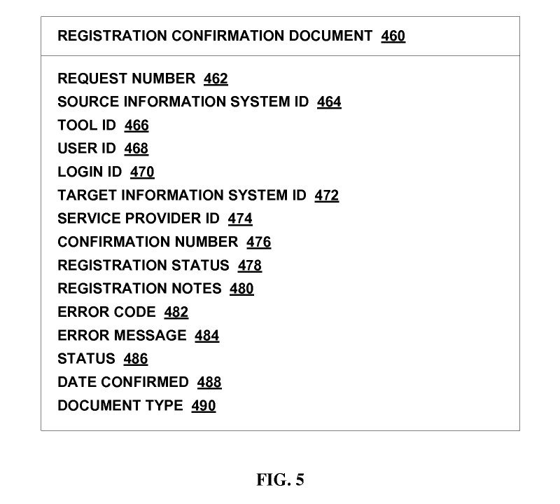

FIG. 5 illustrates an embodiment of a registration confirmation document 460. The registration confirmation document 460 may comprise request number 462, source information system id 464, tool id 466, user id 468, login id 470, target information system id 472, service provider id 474, confirmation number 476, registration status 478, registration notes 480, error code 482, error message 484, status 486, date confirmed 488 and document type 490. The request number 462 may refer to an original request number of a user registration request document. The source information system id 464 may be used to identify a service provider registration information system 140 from which the original registration request document 400 is sent. The tool id 466 may be used to identify the user registration management tool 130. The user id 468 may be used to identify a user. The login id 470 may be login id of the user registration. The target information system id 472 may be used to identify the service provider registration information system 140 that is the direct owner of the service provider of the user registration. The service provider id 474 may be used to identify the service provider of the user registration. The confirmation number 476 may be used to identify a registration confirmation document alone or combined with other fields. The registration status 478 may have values such as APPROVED, ACTIVATED, REJECTED, PENDING or CANCELLED. The date confirmed 488 may be the date and time when the request confirmation document is created. The document type 490 may indicate which document type is used in the registration confirmation document. The registration confirmation document 460 may use any document types that include, but not limited to plain text, XML, EDI, XLS or PDF.

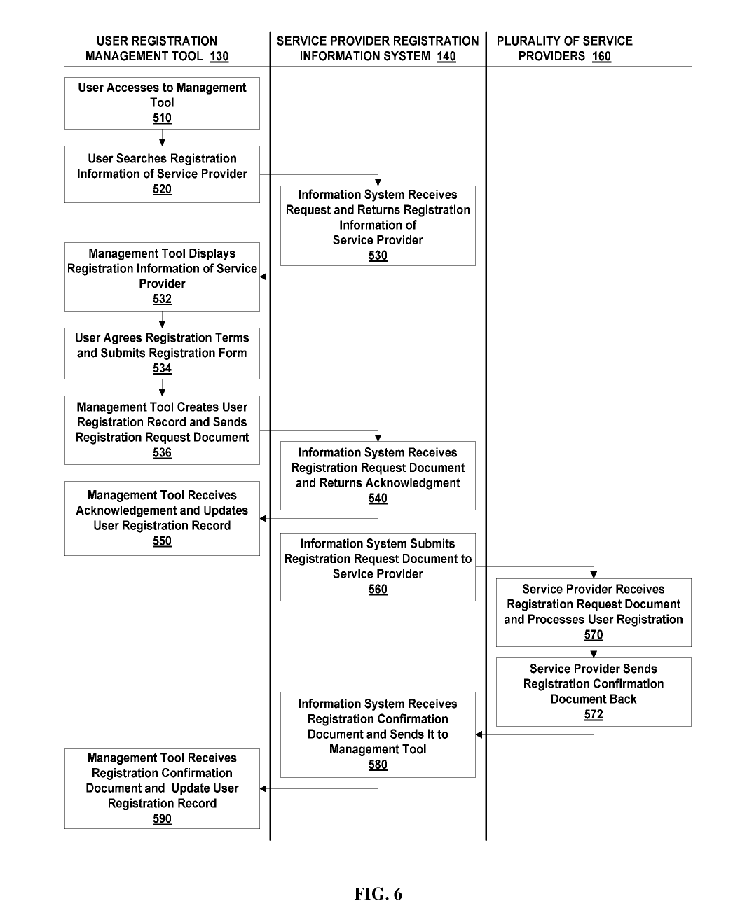

FIG. 6 illustrates an embodiment of a method for processing a user registration in an integration process. The Internet user 110 accesses the user registration management tool 130 (Step 510). The Internet user 110 searches registration information of a specific service provider by browsing the list of the plurality of service providers 160 or searching the service provider by name or other keywords (Step 520). The service provider registration information system 140 receives the search request and returns the registration information of the service provider (Step 530). The user registration management tool 130 displays the registration information of the service provider (Step 532). The Internet user 110 reads and agrees with terms of use and registration policies of the service provider, then fills and submits a registration form to the user registration management tool 130 (Step 534). The user registration management tool 130 creates a user registration record for the service provider with status SUBMITTED, then sends a registration request document 400 to the service provider registration information system 140 (Step 536). The service provider registration information system 140 receives the registration request document 400 and saves a user registration request record with status REQUEST_RECEIVED, then returns an acknowledgment to the user registration management tool 130 (Step 540). The user registration management tool 130 receives the acknowledgment and updates the user registration record with status ACKNOWLEDGED (Step 550). The service provider registration information system 140 submits the registration request document 400 to the service provider. (Step 560). The service provider receives the registration request document 400 and processes the user registration (Step 570). Then the service provider sends a registration confirmation document 460 back to the service provider registration information system 140 (Step 572). The service provider registration information system 140 receives the registration confirmation document 460 and updates the user registration request record, then sends the registration confirmation document 460 back to the user registration management tool 130 (Step 580). The user registration management tool 130 receives the registration confirmation document 460 and updates the user registration record with status CONFIRMED or COMPLETED (step 590). The registration status of the user registration record is also updated based on the registration confirmation document 460. The registration status may have values such as APPROVED, ACTIVATED, REJECTED, PENDING or CANCELLED.

The document types of both the registration request document 400 and the registration confirmation document 460 may be, but not limited to plain text, XML, EDI, XLS or PDF. The user registration management tool 130 and the plurality of the service providers 160 may use same or different document types as well as same or different document structural formats. The service provider registration information system 140 is responsible for mapping document types and document structural formats of the registration request document 400 and the registration confirmation document 460 between the user registration management tool 130 and the plurality of the service providers 160. It is recommended that the service provider registration information system 140 defines a standard document type and document structural format for the registration request document 400 and the registration confirmation document 460.

The protocol of transmitting the registration request document 400 and the registration confirmation document 460 may be, but not limited to HTTP/HTTPS, FTP/SFTP, AS2/AS3, SMTP, SOAP or EDI Van. The user registration management tool 130 and the plurality of the service providers 160 may use same or different protocols to transmit the registration request document 400 and the registration confirmation document 460. As an integration mediator, the service provider registration information system 140 is responsible for mapping and transmitting these documents between the user registration management tool 130 and the plurality of the service providers 160 regardless of their technical capabilities and protocols.

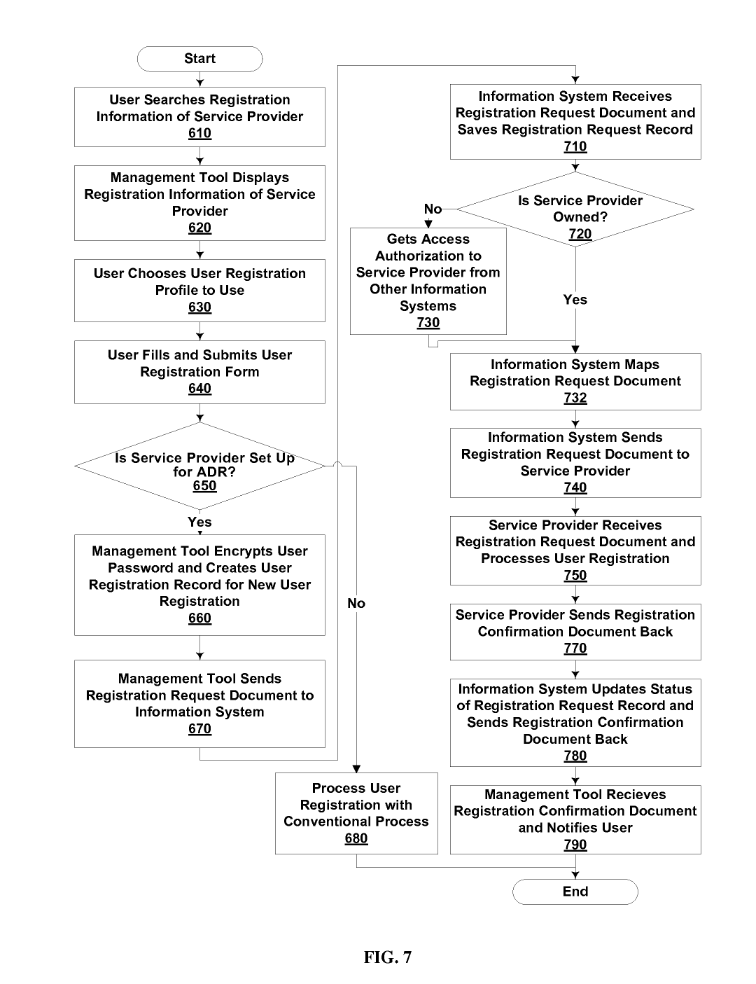

FIG. 7 illustrates an alternative embodiment of a method for processing user registration in flowchart diagram of creating a new user registration. Using the user registration management tool 130, the Internet user 110 searches registration information of a specific service provider within the plurality of service providers 160 (Step 610). The user registration management tool 130 displays the registration information of the service provider (Step 620). After reading and agreeing to terms of use and registration policies of the service provider, the Internet user 110 may choose one of his or her user registration profiles 220 (Step 630). The Internet user 110 fills the registration form by using the user registration profile chosen or directly entering user registration data, then submits the registration form to the user registration management tool 130 (Step 640). The user registration management tool 130 checks if ADR process is set up for the service provide (Step 650). If ADR process is set up, the user registration process will use ADR process and go to Step 660. Otherwise the user registration process will use the conventional registration process and go to Step 680.

In the ADR process, the user registration management tool 130 encrypts password and creates a registration request document 400 with action CREATE (Step 660). The user registration management tool 130 sends the registration request document 400 to the service provider registration information system 140 (Step 670). The service provider registration information system 140 receives the registration request document 400 and saves a user registration request record with status REQUEST_RECEIVED (Step 710). The service provider registration information system 140 may check if the service provider is directly owned by itself (Step 720). If owning the service provider directly, the service provider registration information system 140 has the access authority to the service provider and goes to Step 732. Otherwise the service provider registration information system 140 will go to get access authority to the service provider from the owner of the service provider (Step 730), then go to Step 732. The owner of the service provider is one within the plurality of other service provider registration information systems 150. The service provider registration information system 140 maps the registration request document 400 with document types and document structural formats between the user registration management tool 130 and the service provider (Step 732). The service provider registration information system 140 sends the registration request document 400 to the service provider and updates the status of the registration request record to REQUEST_SENT (Step 740). The service provider receives the registration request document 400 and processes the user registration, including activities such as decrypting user password, saving login id and password, and activating the user registration (Step 750). The service provider sends a registration confirmation document 460 back to the service provider registration information system 140 (Step 770). The service provider registration information system 140 receives the registration confirmation document 460 from the service provider, then sends the registration confirmation document 460 to the user registration management tool 130 and updates the status of the user registration request record to CONFIRMATION_SENT (Step 780). The user registration management tool 130 receives the registration confirmation document 460, then updates the status of the user registration record to CONFIRMED or COMPLETED and notifies the Internet user 110 (Step 790).

If ADR process is not set up for the service provider, the user registration process will go to the conventional process (Step 680). In the conventional process of user registration, the Internet user 110 is linked to the URL of the registration page of the service provider. The Internet user 110 fills a registration form and submits it to the web site of the service provider.

In summary, the method for processing a user registration in the ADR process includes the following steps:
a) receiving a request from an Internet user to create a user registration request to a service provider within a plurality of service providers at a user registration management tool;
b) encrypting a user password for said user registration request at said user registration management tool;
c) creating a registration request document for said user registration request at said user registration management tool;
d) sending said registration request document from said user registration management tool to a service provider registration information system;
e) mapping said registration request document between said user registration management tool and the service provider at said service provider registration information system;
f) transmitting said registration request document from said service provider registration information system to the service provider;
g) receiving said registration request document from said service provider registration information system at the service provider;
h) processing a user registration based on said registration request document at the service provider;
i) creating a registration confirmation document for said user registration request document at the service provider;
j) sending said registration confirmation document from the service provider to said service provider registration information system;
k) mapping said registration confirmation document between said user registration management tool and the service provider at said service provider registration information system;
l) transmitting said registration confirmation document from said service provider registration information system to said user registration management tool;
m) receiving said registration confirmation document at said user registration management tool;
n) updating said user registration record and notifying the Internet user.

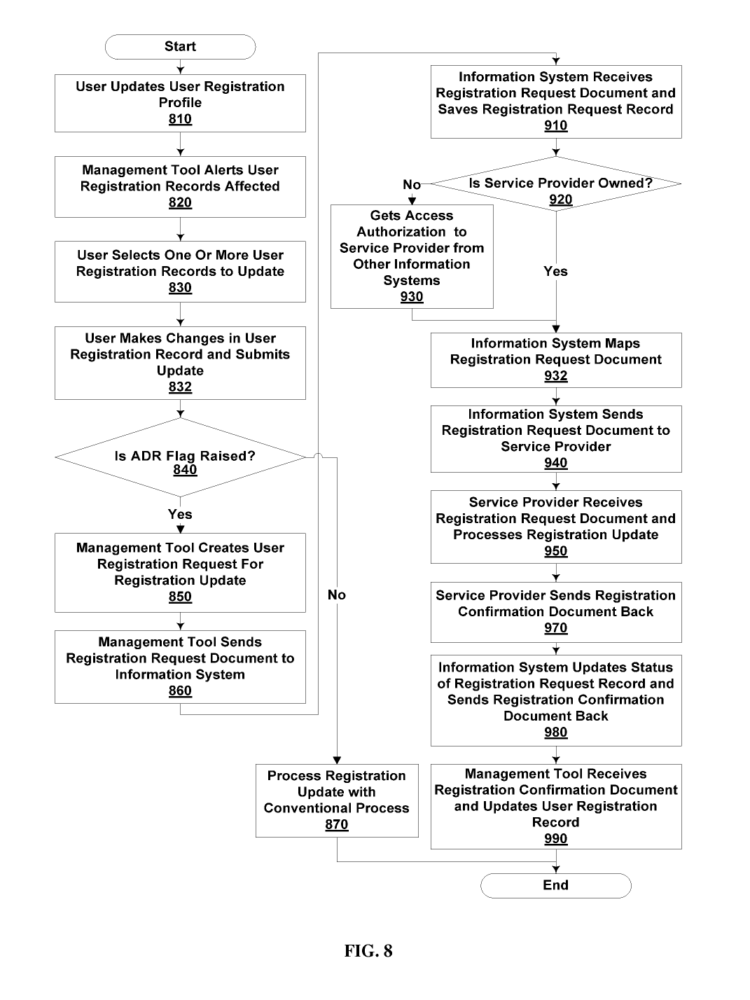

FIG. 8 illustrates an alternative embodiment of a method for processing user registration in flowchart diagram of updating an existed user registration. The Internet user 110 may update one or more of his or her user registration profiles (Step 810). The user registration management tool 130 alerts the Internet user 110 about the user registration records 230 that may be affected because of the change of his or her user registration profiles (Step 820). The Internet user 110 selects one or multiple user registration records to update (Step 830). For every user registration record selected, the Internet user 110 may make changes in login/user password, contact address or other information and submit the update request (Step 832). The user registration management tool 130 checks if the user registration record has ADR flag raised (Step 840). If ADR flag is raised, the registration update will use ADR process and go to Step 850. Otherwise the registration update will use the conventional process and go to Step 870.

In ADR process, the user registration management tool 130 may encrypt password if user password is changed, and then create a registration request document 400 with action UPDATE (Step 850). The user registration management tool 130 sends the registration request document 400 to the service provider registration information system 140 (Step 860). The service provider registration information system 140 receives the registration request document 400 and saves a user registration request record with status REQUEST_RECEIVED (Step 910). The service provider registration information system 140 may check if the service provider is directly owned by itself (Step 920). If owning the service provider directly, the service provider registration information system 140 has access authority to the service provider and goes to Step 932. Otherwise the service provider registration information system 140 will get access authority to the service provider from the owner of the service provider (Step 930), then to go to Step 932. The owner of the service provider is within the plurality of other service provider registration information systems 150. The service provider registration information system 140 maps the registration request document 400 with document types and document structural formats between the user registration management tool 130 and the service provider within the plurality of service providers 160 (Step 932). The service provider registration information system 140 sends the registration request document 400 to the service provider and updates the status of the user registration request record to REQUEST_SENT (Step 940). The service provider receives the registration request document 400 and processes the registration update with the changed information such as encrypted password or contact address (Step 950). The service provider sends a registration confirmation document 460 back to the service provider registration information system 140 (Step 970). The service provider registration information system 140 receives the registration confirmation document 460, then sends the registration confirmation document 460 back to the user registration management tool 130 and update the status of the user registration request record to CONFIRMATION_SENT (Step 980). The user registration management tool 130 receives the registration confirmation document 460 and updates the status of the user registration record to COMPLETED (Step 990).

If ADR flag of the user registration record is not raised, the registration update may use the conventional process. In the conventional process of registration update, the Internet user 110 is linked to the URL of the login page of the service provider. The Internet user 110 logins to his or her user account and updates the user registration information such as user password or contact address on the web site of the service provider.

In the conventional process of user registration, an Internet user has to visit every individual web site to process user registration respectively. With the ADR process, the user registration management tool 130 allows the Internet user 110 to create or update multiple user registrations at once. Instead of visiting each web site of the plurality of service providers 160, the Internet user 110 may use the single interface provided by the user registration management tool 130 to process all of user registrations. The Internet user 110 would not experience tedious interactions or errors of processing user registrations because the procedure of user registration is transparent to the Internet user 110 and is done by the user registration management tool 130.

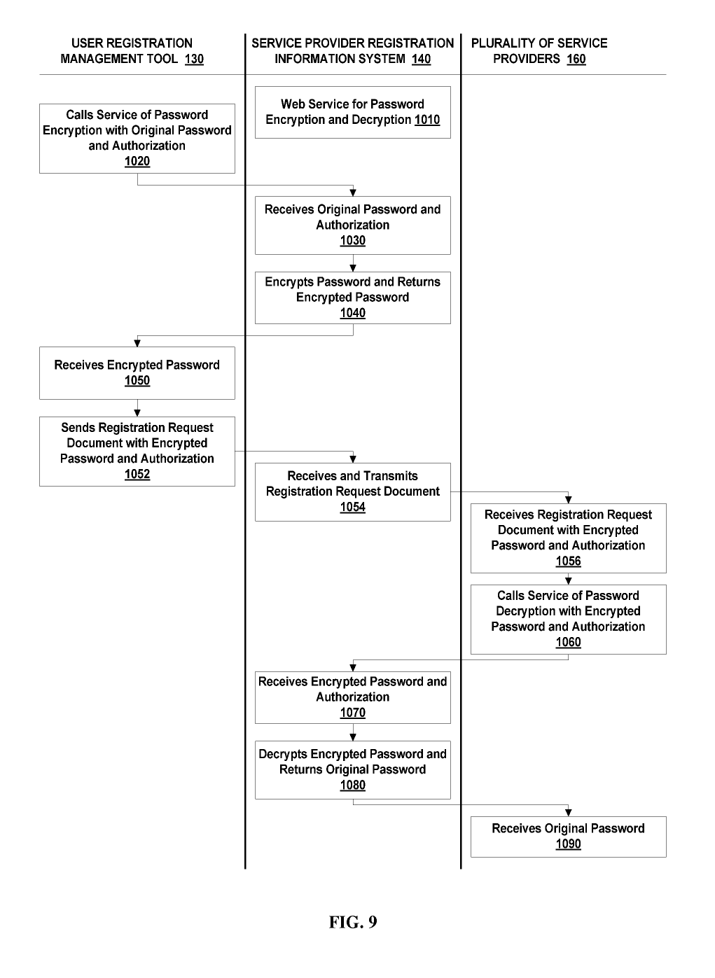

FIG. 9 illustrates a possible embodiment of a method for processing a user registration in flowchart diagram of encrypting and decrypting a use password. The service provider registration information system 140 provides a web service for password encryption and decryption 1010. The user registration management tool 130 calls the web service 1010 with an original user password and an authorization for encrypting password (Step 1020). The web service 1010 receives the original password and the authorization (Step 1030). The web service 1010 encrypts the original user password and returns an encrypted password to the user registration management tool 130 (Step 1040). The user registration management tool 130 receives the encrypted password (Step 1050). The user registration management tool 130 sends the registration request document 400 that includes the encrypted password and the authorization to the service provider registration information system 140 (Step 1052). The service provider registration information system 140 receives the registration request document 400 and transmits it to the service provider within the plurality of service providers 160 (Step 1054). The service provider receives the registration request document 400 that includes the encrypted password and the authorization (Step 1056). The service provider calls the web service 1010 with the encrypted password and the authorization for decrypting password (Step 1060). The web service 1010 receives the encrypted password and the authorization (Step 1070). The web service 1010 decrypts the encrypted password and returns the original user password to the service provider (Step 1080). The service provider receives the original user password and processes the user registration (Step 1090).

For security reason, the user password of user registration needs to be encrypted in the registration request document 400. There are several ways for password encryption and decryption between the user registration management tool 130 and the plurality of service providers 160. In FIG. 9 above, the user registration management tool 130 and the plurality of service providers 160 use the same web service for password encryption and decryption 1010 to encrypt and decrypt user password. The encryption method to encrypt the user password includes, but not limited to MD5, SHA-1, RSA, DES, Triple-DES or Tokenization.

What is claimed is:

1. A system for managing multiple user registrations, comprising a user registration management tool, said user registration management tool comprising a user registration management interface and allowing an Internet user to manage his or her user registrations, said user registration management interface comprising means for creating user registration records, said means for creating user registration records allowing the Internet user to create a user registration record to a service provider within a plurality of service providers.

2. The system of claim 1, wherein said user registration record comprises a user id, a login id, a service provider URL.

3. The system of claim 1, wherein said user registration management interface further comprises means for updating user registration records, said means for updating user registration records allowing the Internet user to update said user registration record.

4. The system of claim 1, wherein said user registration management interface further comprises
a) means for managing user registration profiles, said means for managing user registration profiles comprising
i) creating said user registration profiles;
ii) updating said user registration profiles;
b) means for managing user registration books, said means for managing user registration books comprising
i) creating said user registration books;
ii) updating said user registration books;
iii) importing said user registration books;
iv) exporting said user registration books.

5. The system of claim 1, wherein said user registration management tool further comprises a user registration database, said user registration database comprising
a) user registration profiles, said user registration profiles storing user information for user registration;
b) user registration records, said user registration records storing records of user registrations to said plurality of service providers;
c) user registration books, said user registration books storing a collection of said user registration records.

6. The system of claim 1, further comprising a service provider registration information system, said service provider registration information system hosted on at least one server comprising a service provide registration management interface, said service provide registration management interface comprising means for managing service provider registration information and communicating with said plurality of service providers via a Network.

7. The system of claim 6, wherein said means for managing service provider registration information comprises
a) registering service providers, said registering service provider allowing said plurality of service providers to register to said service provider registration information system;
b) creating service provider registration information;
c) updating said service provider registration information;
d) retrieving said service provider registration information.

8. The system of claim 6, wherein said service provider registration management interface further comprises means for managing user registration requests, said means for managing user registration requests comprising
a) transmitting a registration request document;
b) mapping said registration request document between said user registration management tool and said plurality of service providers.

9. The system of claim 8, wherein said means for managing user registration requests further comprises
a) transmitting a registration confirmation document;
b) mapping said registration confirmation document between said user registration management tool and said plurality of service providers.

10. The system of claim 8, wherein said registration request document comprises a request number, a login id and an encrypted password.

11. The system of claim 9, wherein said registration confirmation document comprises a confirmation number, a request number and a registration status.

12. The system of claim 6, wherein said service provider registration management interface further comprises means for sharing with other registration information systems, said means for sharing with other registration information systems comprising
a) connecting to a plurality of other service provider registration information systems via the Network;
b) obtaining authority access to the registration information of said plurality of service providers;
c) sharing the registration information of said plurality of service providers with said plurality of other service provider registration information systems.

13. The system of claim 6, where said service provider registration information system further comprises a registration information database, said registration information database comprising
a) service provider registration information, said service provider registration information storing the registration information of said plurality of service providers;
b) user registration request records, said user registration request records storing the user registration requests;
c) shared registration information systems, said shared registration information systems storing information of the plurality of other service provider registration information systems.

14. The system of claim 13, wherein said service provider registration information includes a service provider name, a service description, terms of use and registration policies.

15. A system for managing multiple user registrations, comprising
a) a user registration management tool, said user registration management tool comprising
1) a user registration management interface, said user registration management interface comprising
i) means for creating user registration records, said means creating user registration records allowing an Internet user to create a user registration record to a service provider within a plurality of service providers;
ii) means for updating user registration records, said means updating user registration records allowing the Internet user to update said user registration record;
iii) means for managing user registration profiles, said means for managing user registration profiles allowing the Internet user to create said user registration profiles;
iv) means for managing user registration books, said means for managing user registration books allowing the Internet user to create said user registration books;
2) a user registration database, said user registration database comprising
i) user registration profiles, said user registration profiles storing user information for user registration;
ii) user registration records, said user registration records storing records of user registrations to a plurality of service providers;
iii) user registration books, said user registration books storing a collection of said user registration records;
b) a service provider registration information system, said service provider registration information system hosted on at least one server comprising
1) a service provide registration management interface, said service provide registration management interface comprising
i) means for managing service provider registration information, said means for managing service provider registration information comprising
A) registering service providers, said registering service provider allowing said plurality of service providers to register to said service provider registration information system;
B) creating service provider registration information;
C) updating said service provider registration information;
D) retrieving said service provider registration information;
ii) means for managing user registration requests, said means for managing user registration requests comprising
A) transmitting a registration request document;
B) mapping said registration request document between said user registration management tool and said plurality of service providers;
C) transmitting a registration confirmation document;
D) mapping said registration confirmation document between said user registration management tool and said plurality of service providers;
iii) means for sharing with other registration information systems, said means for sharing with other registration information systems comprising
A) connecting to a plurality of other service provider registration information systems via the Network;
B) obtaining authority access to the registration information of said plurality of service providers;
C) sharing the registration information of said plurality of service providers with said plurality of other service provider registration information systems;
2) a registration information database, said registration information database comprising
i) service provider registration information, said service provider registration information storing the registration information of said plurality of service providers;
ii) user registration request records, said user registration request records storing said the user registration requests;
iii) shared registration information systems, said shared registration information systems storing information of said plurality of other service provider registration information systems.

16. A method for processing a user registration, comprising:
a) receiving a request from an Internet user to create a user registration request to a service provider within a plurality of service providers at a user registration management tool;
b) encrypting a user password for said user registration request at said user registration management tool;
c) creating a registration request document for said user registration request at said user registration management tool;
d) sending said registration request document from said user registration management tool to a service provider registration information system;
e) mapping said registration request document between said user registration management tool and the service provider at said service provider registration information system;
f) transmitting said registration request document from said service provider registration information system to the service provider;
g) receiving said registration request document from said service provider registration information system at the service provider;
h) processing a user registration based on said registration request document at the service provider.

17. The method of claim 16, wherein said registration request document comprises a request number, a login id and an encrypted password.

18. The method of claim 16, further comprising:
a) creating a registration confirmation document for said user registration request document at the service provider;
b) sending said registration confirmation document from the service provider to said service provider registration information system;
c) mapping said registration confirmation document between said user registration management tool and the service provider at said service provider registration information system;
d) transmitting said registration confirmation document from said service provider registration information system to said user registration management tool;
e) receiving said registration confirmation document at said user registration management tool;
f) updating the user registration record at said user registration management tool.

19. The method of claim 18, wherein said registration confirmation document comprises a confirmation number, a request number and a registration status.

20. The system of claim 4, wherein said user registration books comprise a collection of said user registration records.
